(19) United States
(12) Patent Application Publication
(10) Pub. No.: US 2007/0150840 A1
(43) Pub. Date: Jun. 28, 2007

(54) Browsing stored information

(76) Inventors: Andrew Olcott, Newtonville, MA (US); Lisa Debettencourt, Lowell, MA (US); James T. Hotary, Princeton, MA (US); Richard Moon, Sudbury, MA (US); John Michael Sakalowsky, West Newton, MA (US)

Correspondence Address: FISH & RICHARDSON PC, P.O. BOX 1022, MINNEAPOLIS, MN, 55440-1022, US

(21) Appl. No.: 11/317,558

(22) Filed: Dec. 22, 2005

(51) Int. Cl. G06F 3/00

(52) U.S. Cl. 715/854

(57) ABSTRACT

A geographical field is displayed including indicia, representing respective items stored in a navigation system, that are displayed in positions that correspond to geographic relationships of the items on the geographic field. In response to a user manipulating a user interface control device, a visible feature of the geographic field is altered to indicate browsing with respect to a predetermined succession of the stored items.

### BACKGROUND

This description relates to browsing stored information.

In typical display-based navigation systems used in vehicles, for example, user interface controls such as buttons on a dashboard console enable a user to browse through lists of words or phrases representing items in a database of stored information such as information about interstate highways, state roads, and streets. It has also been proposed to enable a user to scroll back and forth through displays of individual segments of a route based on information stored in a database.

### SUMMARY

In general, in one aspect, a geographical field is displayed including indicia, representing respective items stored in a navigation system, that are displayed in positions that correspond to geographic relationships of the items on the geographic field. In response to a user manipulating a user interface control device, a visible feature of the geographic field is altered to indicate browsing with respect to a predetermined succession of the stored items.

Implementations include one or more of the following features. The altering of a visible feature comprises changing an appearance of at least one of the indicia. The items comprise points of interest in a vicinity of a route on the geographical field. Text identifiers of at least some of the selected items are also displayed in positions that do not correspond to geographic relationships of the items. The indicia are displayed as a hub representing one of the items and spokes representing other items that have a geographical relationship to the one item, the angles of the spokes and the distances separating the hub and the spokes being representative of the directions and distances among the items represented by the hub and the spokes. The user is enabled selectively to cause, at one time, either a geographical display of the indicia, text identifying the selected items, or both a geographical display of the indicia and text identifying the selected items. The geographical field is represented as a map of a region being navigated and the indicia are displayed on the map. The stored items are organized in hierarchical levels. The items represented by the indicia belong to one of the levels. The user is enabled to select items at each of at least two different hierarchical levels by manipulating the user interface. The items comprise points of interest. A cursor is displayed to indicate currently selected items. In response to a user request, additional information is provided about currently selected items. The manipulating of a control device comprises turning a knob. The visible feature of the geographic field comprises a cursor, and altering the visible feature comprises causing the cursor to point to successive indicia representing the stored items. The predetermined succession of items is determined automatically. The user manipulating the user interface control device is not associated with an inherent geographic aspect. The user manipulating the user interface control device requires no knowledge by the user of the location on the geographical field of the next item in the predetermined succession of items.

Other general aspects include other combinations of the features recited above and other features expressed as methods, apparatus, systems, program products, and in other ways.

Other advantages and features will become apparent from the following description and from the claims.

### DESCRIPTION OF DRAWINGS

FIG. 1A is a block diagram.

FIGS. 1B, 6A, 8A, and 9A show hierarchies.

FIGS. 1C, 2A, 2B, 2C, 3A, 3B, 4A, 4B, 5, 6B, 7A, 7B, 8B, 8C, 8D, 8E, 9B, 11A, 11B, and 12 show screen shots, in some cases with hierarchies.

FIG. 10 shows an icon.

### DETAILED DESCRIPTION

By improving the way a user can visually browse records stored in a database, finding items of interest and understanding their significance (for example, the locations of Chinese restaurants on a displayed regional map) becomes faster, easier, and more intuitive. The records in the database may relate to (and provide information about) items that are not simply route segments, but rather are attractions in the vicinity of, or supplemental features of, a route or a region or other spatial field that is being displayed. The user can narrow the scope of the items that he will browse by browsing a displayed textual hierarchy of the items to select one or more nodes or leaves of the hierarchy of items (for example, restaurants that serve Italian food). Once the nodes or leaves are selected, the user can visually browse the items in those nodes or leaves, one item at a time, back and forth, using a user interface device such as a knob to select a current item of interest. The user can alternate between browsing the hierarchy and browsing the items in selected nodes or leaves of the hierarchy because the display can show both the textual hierarchy and a map of the items of that are selected in the hierarchy at a given time. Or the textual hierarchy can be hidden to permit a more complete map display of the items being browsed.

The items of the selected portion of the hierarchy are indicated by icons or other indicia displayed on a map (or other two-dimensional or three-dimensional representation). All of the items in that portion of the hierarchy can be indicated simultaneously on the map. The current item of interest selected by the user can be distinguished visually using different indicia than are used for the other displayed items that are not the currently selected item. Displaying all of the items of the portion of the hierarchy at once while highlighting a selected one of them enables the user to comprehend easily the relationship of the different items to the local region and their relationship to one another and their relationship to a current vehicle location.

In other examples, the intersections of roads may be organized hierarchically in the database, and the user can select a set of intersections from the hierarchy and then browse successive intersections within that set (for example, all roads that intersect Main Street in Bristol, Rhode Island). The roads selected need not have any relationship to a current position of the vehicle or to a programmed route.

In the examples described above, the hierarchy of items in the database is not displayed explicitly on the map. Rather, only the items within a selected portion of the hierarchy are displayed on the map as the user browses. In some examples, however, the hierarchy is explicitly displayed. In some cases, the hierarchical display provides an abstracted rather than literal view of the positional relationships among the levels of the hierarchy and the items of a given node or leaf. The display, for example, can use a hub and spoke approach to display the geographical relationships of countries, states, and towns.

In some examples, it would also be possible to display the hierarchical relationships of items in the database on the map itself. Items that are displayed on the map generally have a geographic aspect. Items at any level of the database hierarchy that exhibit such a geographic aspect, can be displayed, for example, all Italian restaurants or all Chinese restaurants. For example, all attractions could be indicated by a relatively small unobtrusive visual indicia on the map. All gasoline stations could then be indicated by another, slightly more noticeable indicia, all restaurants by a different indicia, and so on. All Chinese restaurants could be shown by an even more noticeable indicia, and so forth. Each restaurant could be shown by a knife and fork icon, for example, and each Chinese restaurant by the same knife and fork icon with a Chinese character overlaid on it. In some cases, the user could be permitted to choose multiple nodes and leaves of the hierarchy for visual display and exclude others. For example, the user could select Chinese restaurants and Italian restaurants to see whether the nearest Italian restaurant (his second favorite cuisine) is much closer than any Chinese restaurant (his favorite cuisine).

Each time a user moves from one item to a new current item from the database, details about that item stored in the database may be displayed (for example, the address or telephone number of the restaurant).

The user is also enabled to zoom in and out with respect to the displayed map to see more or less detail, and the zooming can be done in conjunction with each of the successive currently selected items. For example, when the user has currently selected the China Moon restaurant, he can zoom in on the portion of the map in the vicinity of the icon that indicates the location of that restaurant. He can then change the current item to another Chinese restaurant and zoom on that one. Separate controls can be provided for that purpose.

Sometimes we use the phrase geographical field broadly to refer, for example, to all of the displayed elements that have geographic meaning or are related to elements that have geographic meaning, including the map, cursors, text, roads, points of interest, and other indicia displayed with the map or any of the other geographical elements.

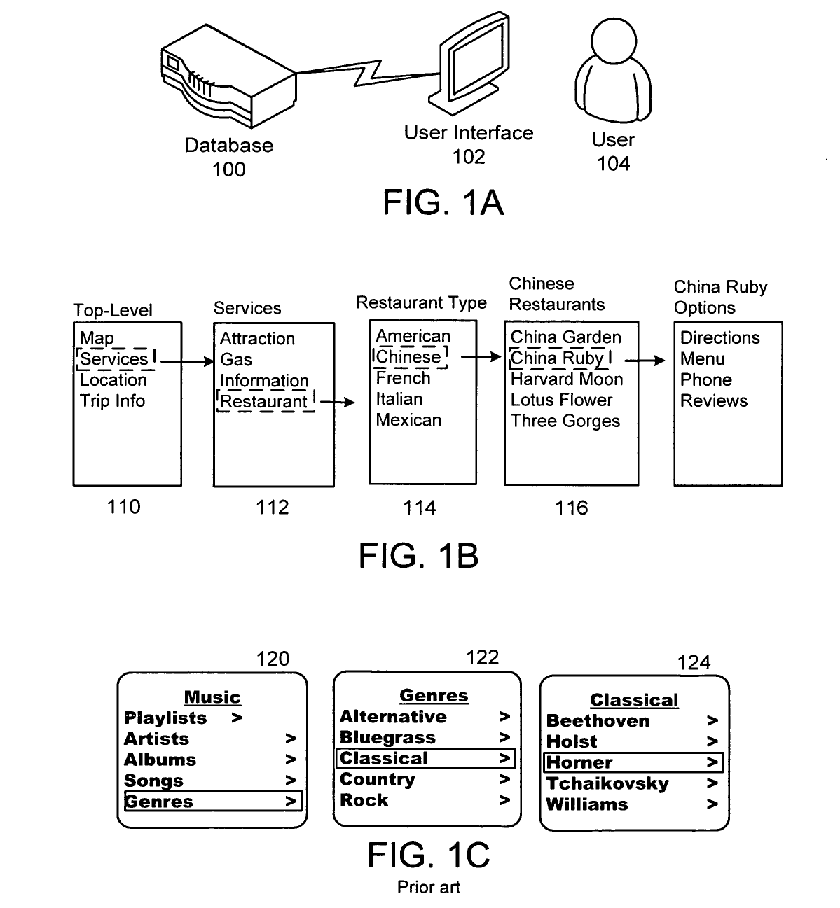

As illustrated in FIG. 1A, a database 100 of records can be accessed and browsed by a user 104 using controls of a user interface 102. The user interface 102 and the database can be part of any of a wide variety of devices including a general-purpose computer running an operating system and applications to manage the database and the interface, among other things. Other devices could include dedicated workstations, portable computers, and hand-held devices including personal digital assistants and mobile telephones. In addition, the user interface and the database could be operated on two or more different devices, and the devices could be in the same location or different locations. Different devices could interact through any kind of communication network including a local area network, a wide area network, and the internet. The database may include any kind of information.

In some implementations, described by example below, the database includes navigation information useful for a display-based navigation system of a vehicle. The user interface is exposed to the occupants of the vehicle through a console, for example, a dashboard mounted console. The user interface and the database are managed by software running on an on-board computer in the vehicle.

One simple example of a portion of the database 100 is illustrated in FIG. 1B. The records of the database may be organized hierarchically in successive levels beginning with a root node. The root node could represent an action associated with the levels below, for example, “find nearby” Each of the other levels can have multiple nodes. Leaves of the hierarchy occur at the opposite end from the root node. The records in a top level 110 of the hierarchy (in FIG. 1B, the root node is just to the left of the top level node 110) represent functions performed by a vehicle navigation system, e.g. Map (which refers to the display of maps on the navigation system screen), Services (which refers to display of services that may be available to motorists at facilities located on or near the vehicle's route), Location (display of information about the vehicle's current location), and Trip Info (display of information about a current trip of the vehicle).

Each record in the first level 110 of the hierarchy represents a node that is associated with a set of nodes at a second level 112 of the hierarchy. For example, associated with Services in the first level are the nodes Attraction (sites that may be of interest to the vehicle occupants), Gas (places to buy fuel), Information (information about places, geography, history, and the like), and Restaurant (names and other information about eating places). Likewise, a third level 114 has nodes that correspond to each node in the second level. Continuing the example of FIG. 1B, the restaurant node corresponds to the nodes 114 including American, Chinese, French, Italian, and Mexican. In the fourth level 116, Chinese restaurants are associated with records for China Garden, China Ruby, Harvard Moon, Lotus Flower, and Three Gorges. At the fifth level 118 of the hierarchy of the database in FIG 1B are the types of information available about each restaurant at the fourth level 116. A sixth level of data, not shown, would contain the actual data from the record referred to in the fifth level 118, for example, the menu of the China Ruby Chinese Restaurant that is a Service of interest to the vehicle occupants. Alternatively, a record in the fifth level 118, e.g. Directions, might link to data external to the database 100. The nodes at the fifth level may be thought of as leaves of the hierarchy.

For a geographical region, the database could include a large number of records and a reasonably complex hierarchy of nodes and leaves. This raises the important question: How can the user browse through such a database of information quickly and easily to reach and understand information that is useful to him?

Often browsing is aided by a combination of displaying to the user portions of the hierarchy in text and the information from the records represented by the hierarchy, and enabling the user to indicate choices through devices of a user interface.

In some existing browsing systems, information in a database is presented to a user in successive menus corresponding to the levels of a hierarchy, for example, the portable music player interface shown in FIG. 1C. Each screen 120, 122, 124 shows the contents of successive levels of the hierarchy, e.g., categories of music, genres, composers. The user's selection of one record in each screen determines which records from the next level are presented in the next screen.

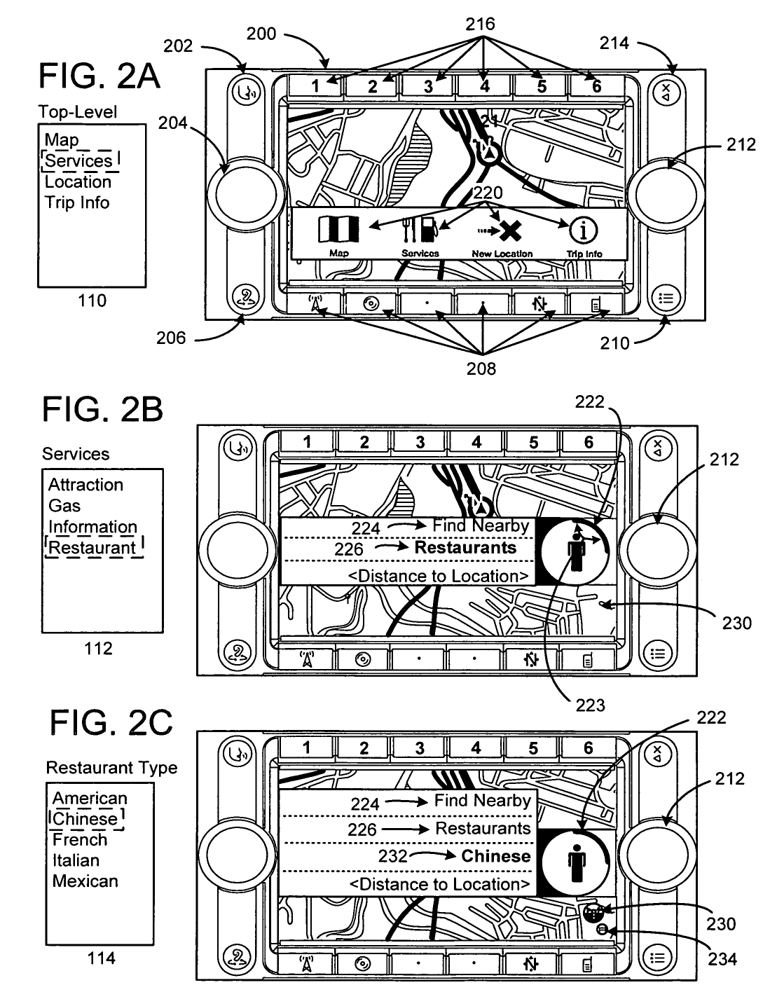

FIGS. 2 through 10 illustrate examples of an improved way to enable a user to browse a database in the context of a vehicle's navigation system.

Referring to FIG. 2A, the interface 200 of the navigation system comprises buttons, knobs, and a display screen combined in a unit that can be mounted in a dashboard of a vehicle, for example. Some buttons, e.g., 202, 206, 210, 214, have specific functions indicated by labels on those buttons. Other buttons, e.g., 208, 216, may have functions that vary depending on the state of the navigation system. Knobs 204, 212 may also have fixed functions or differing functions and may also function as push buttons. The display screen 218 may be a video monitor capable of displaying any image or video stream sent to it, or it may comprise discrete elements such as character displays, individual lights, or static images.

In some examples, as shown in FIG. 2A, the records in a level 110 (from FIG. 1B) of the hierarchical database are represented by icons 220 displayed on a screen 218. The screen may be split for purposes of display so that the icons are shown on the bottom portion and a map is shown on the upper portion. The display of the top level icons as illustrated may be the initial or default display for the system. As shown, in general, the user may select an icon representing a desired function by rotating a designated knob 212 to change which icon is highlighted (in FIG. 2A, it is Services that is highlighted), and then pressing a designated button, which may be the knob 212 used to select the icon.

In some implementations, the user might select a function by directly pressing an icon 220, if screen 218 is sensitive to touch.

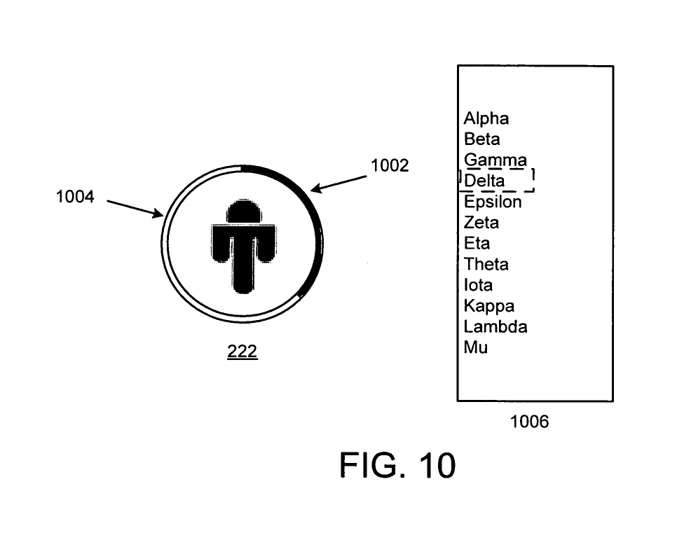

The selecting of one of the icons in FIG. 2A, by rotating a knob and pressing it, causes the display to change to the configuration shown in FIG. 2B, in which selected nodes of the hierarchy at successive levels are displayed, one node per level. In FIG. 2B, only one level of the hierarchy (Restaurants) is shown (in addition to the root node, Find Nearby), and one of the nodes at that level 112 of the hierarchical database is displayed on a line of text 226. The name of the item that was selected in the next higher level is displayed on a higher line of text 224. For the function of locating services, there are multiple ways to define the starting point and scope of the search, for example, services near the vehicle's location, along a calculated route, within a specific city or other area, on a particular cross street, or at a destination or other identified point. In this example, the “Find Nearby” item may represent any of these methods, and does not correspond to the details of the hierarchy shown on earlier figures. The user is able to browse the names of nodes in the level 112 by rotating the knob 212 (FIG. 2A), which changes the name displayed in the line 226 to the successive names (one by one) in a list of the nodes in the level 112 of the hierarchy. A circular icon 222 indicates how far through the list of items in that level of the hierarchy the user has browsed by the angular extent 1002 of the outer ring that is filled in (see FIG. 10, described below). The line of the display that contains the phrase <Distance to Location> indicates an action that can be taken by the user with respect to the selections that appear in the list shown above it. Any of the levels 112, 114 could be visually browsed. For example, one might wish to switch between browsing all Chinese restaurants and browsing all restaurants.

For the third level 114 of the hierarchical database, shown in FIG. 2C, the names of the items at that level are displayed, one at a time, in a third line of text 232, with the selected item in each of the previous two levels displayed in preceding lines of text 224 and 226. The user is able to browse the successive items in level 114 by rotating the knob 212 in the same manner as for FIG. 2B. As with the second level, the icon 222 indicates how far through the list of records in level 114 the user has browsed. At any time and from time to time, whenever the user is browsing in a level of the hierarchy by turning the knob, he can stop browsing, restart again, and reverse direction once or repeatedly. The icon 222 will continue to show at all times the location of the user within the list of items at that level. Being circular, the icon implies to the user that the list of items is a ring in which the final item is followed by the first item again, and the user can use the knob to browse from the end of the list directly to the beginning of the list.

Also shown in FIGS. 2B and 2C are icons 230 and 234.

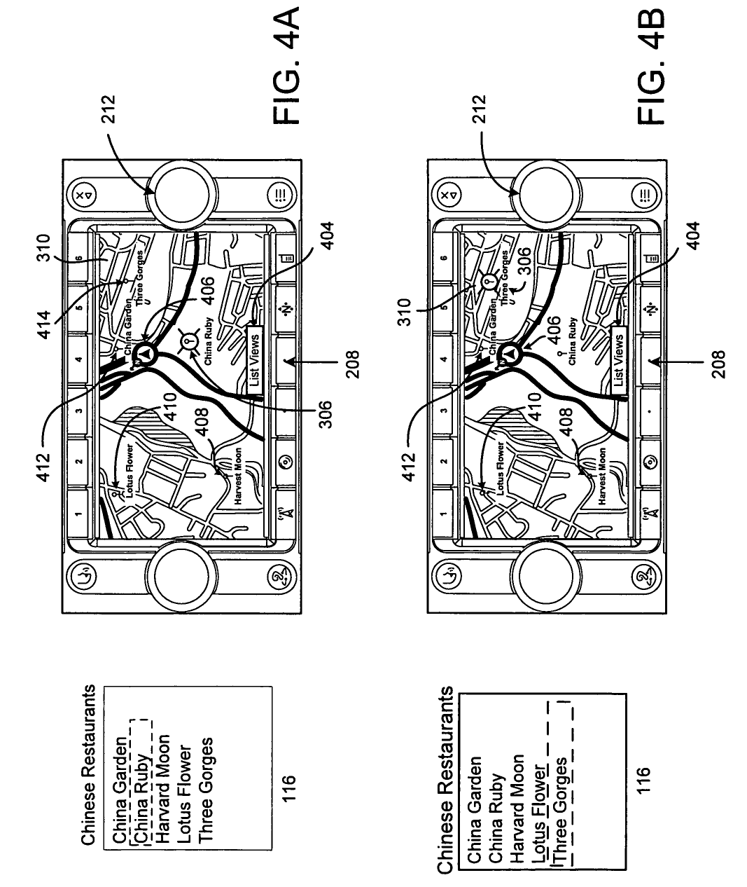

When the information associated with a particular node has a geographic attribute, as in (but not limited to) a navigation system, the information may be displayed visually and the user may be enabled to browse the visual display. For example, for the third level 116 of the hierarchical database, shown in FIG. 4A, the locations of the individual restaurants in that node can be illustrated by icons or other indicia on a map. A cursor 306 indicates the location on a map 310 of the current item selected by the user, a restaurant named “China Ruby”. The textual display of the hierarchy has been hidden in FIG. 4A to permit the user to have an unobstructed view of the map. Several names and pin icons 408, 410, 412, and 414 simultaneously indicate locations of other restaurants on the map 310. An icon 406 indicates the current location of the automobile near the center of the screen, giving additional context to the locations shown for the restaurants. As in the earlier examples, rotating the knob 212 browses among the items of the present subset 116. As shown in FIG. 4B, in response to the user turning the knob 212, the cursor 306 has moved to the location on the map 310 of the “Three Gorges” restaurant. Text 404 indicates that pressing the corresponding button 208 will return the user to the traditional list view of the database.

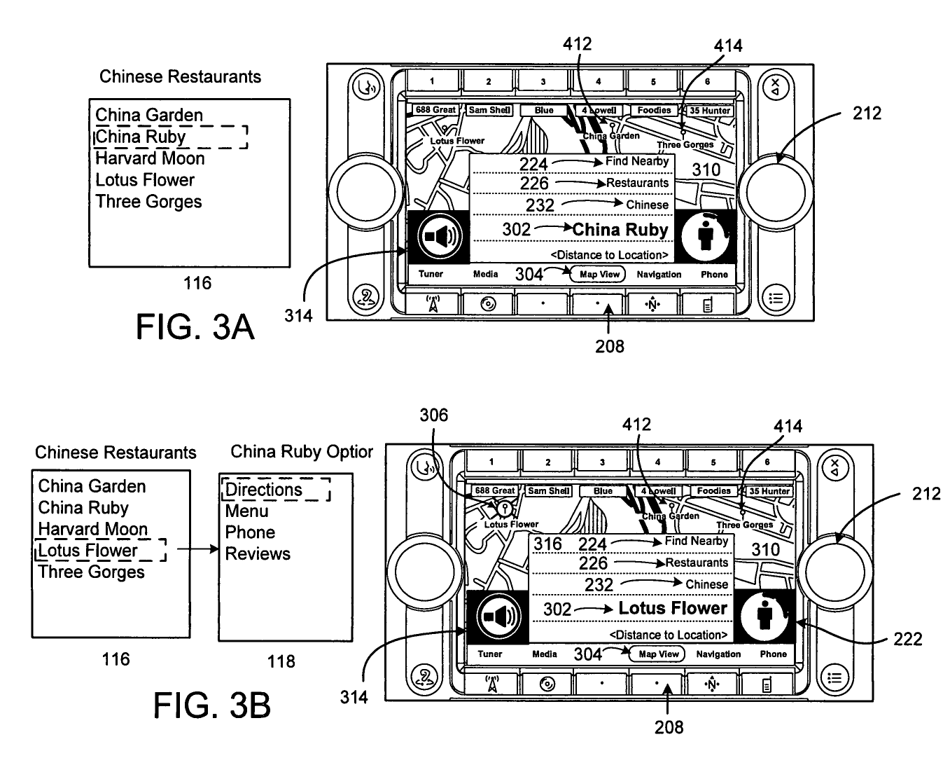

FIGS. 3B illustrates an alternative mode of browsing activated when the user presses the button 208 designated “List View” indicated by the text 404 in FIG. 4A and 4B. The map 310 is still visible and the display of the hierarchy is also displayed. To accommodate the map, the display of the hierarchy has been reduced in size, the icon 222 has been reduced in size and relocated, and a new icon 314 has been added. The names of the restaurants are displayed in a fourth line of text 302, one at a time, with the selected item from each of the previous three levels displayed in preceding lines of text 224, 226, and 232. As with the other levels, the user is able to browse the records in level 116 by rotating knob 212 and, icon 222 indicates how far through the list of records in level 116 the user has browsed.

The restaurant listed on line 302 (FIG. 3B) is identified on the map by an icon (a pin within the cursor 306) The other restaurants in the list (the ones that are present on the portion of the map displayed) are identified by names and pin icons 412 and 414 as in FIG. 4A. The text 404 (FIG. 4A) has been replaced by the text 304, indicating that pressing the corresponding button 208 will return the viewer to the Map View. Using the button 208, the user may toggle back and forth between the view shown in FIG. 3B, which includes the list view showing the list and a portion of the map,, and the view, shown in FIG. 4A, for example, in which the list is hidden and only the map is shown. An item highlighted in one view will also be highlighted in other view.

When a user is browsing in one view, the information necessary for displaying the other view can be processed in the background. For example, when an item is selected in the list view, the information for rendering the map in the map view can be calculated at the same time, so that the system can switch rapidly to the alternative view when requested to do so by the user. In FIGS. 3A and 3B, one view is overlaid on top of the other view, and both views are updated at the same time. The system may also accommodate highlighting more than one item at a time. For example, all Chinese restaurants may be highlighted, or all Italian restaurants, or all gas stations.

FIGS. 3A and 3B illustrate the change in the display as the user rotates knob 212 to choose among items in level 116. As the knob 212 is rotated, the item listed in 302 changes from “China Ruby” to “Lotus Flower.” Meanwhile, the outer ring of the icon 222 indicates that the user is farther through the records in the present level, and the icon 306 now indicates the location of the “Lotus Flower” restaurant on the map 310 in the background. Thus the user can browse the database by rotating the knob which causes successive items to be indicated by both the line 302 and the icon cursor on the map.

In the example of FIG. 3A and 3B, an icon 314 representing the volume of the vehicle's audio system is displayed on the left side of screen 218. The current volume level relative to the maximum potential volume level is represented by the extent to which the outer ring of volume icon 314 is filled in.

A line 312 corresponds to the next level 118 of the hierarchy that will be displayed once the user has selected a restaurant in line 302 from level 116. The choice currently shown enables the user to display the distance to the restaurant. Other actions may include <indicate route>.

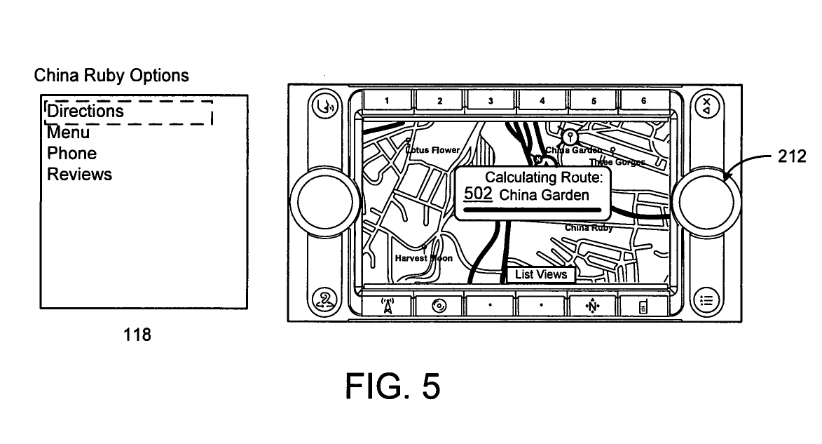

As illustrated in FIG. 5, once a user chooses to see a route to his selected restaurant, as this operation may take some time to complete, the screen 218 may display an indication 502 that the user's request is being processed.

Using the interface illustrated and described above, a user can browse rapidly, easily, and intuitively through a database to find information of interest.

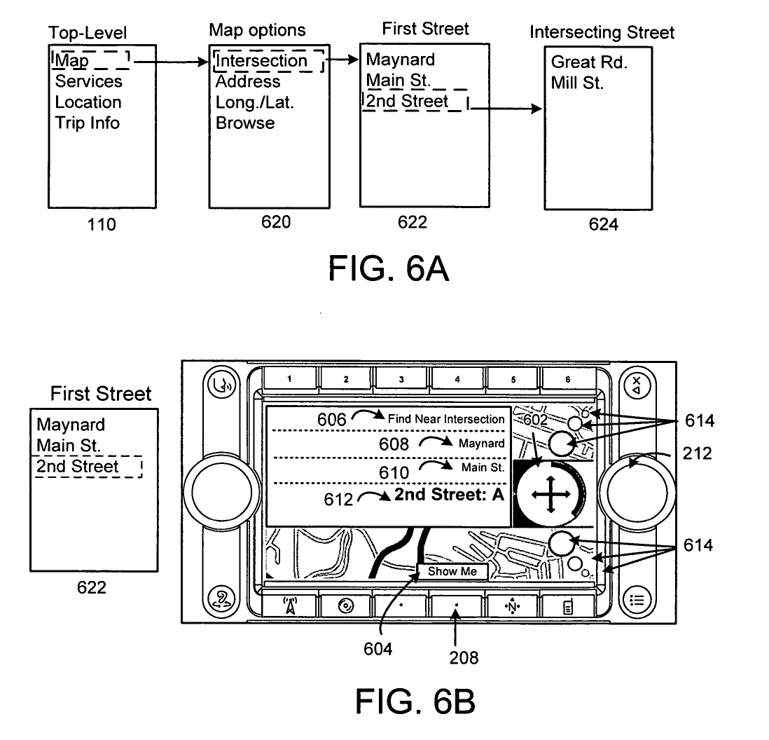

In some implementations, a vehicle navigation system may be used to find a street intersection. FIG. 6A shows an example of the nodes in a hierarchical database that support this function. Other database formats may be used. In a second level 620, records representing various ways of locating a point on a map correspond to the Map service at the top level 110 (from FIG. 1B). For the intersection item, subsets of records in a third level 622 each contain streets that could be the first street of an intersection. A set of records at a fourth level 624 contains streets that intersect 1st Street, the street selected in level 622.

FIG. 6B shows an example of a user interface for accessing intersection information from a database. Line 606 indicates the currently selected mode (in this case, “Find Nearby Intersection”). The line 608 indicates possible cities in which intersections of streets occur. The line 610 indicates possible first streets that could be associated with intersections in the selected city. The line 612 indicates streets that intersect the street selected in line 610. The line 612 is aligned with an icon 602, that indicates (by the drawing of an intersection) the currently active mode that corresponds to the text on line 606. Other possible modes are indicated by icons 614.

Rotating knob 212 would change the selection on line 612 to other streets. The portion of the outer ring of the icon 602 that is darkened indicates how far through the records of the level 622 the user has browsed.

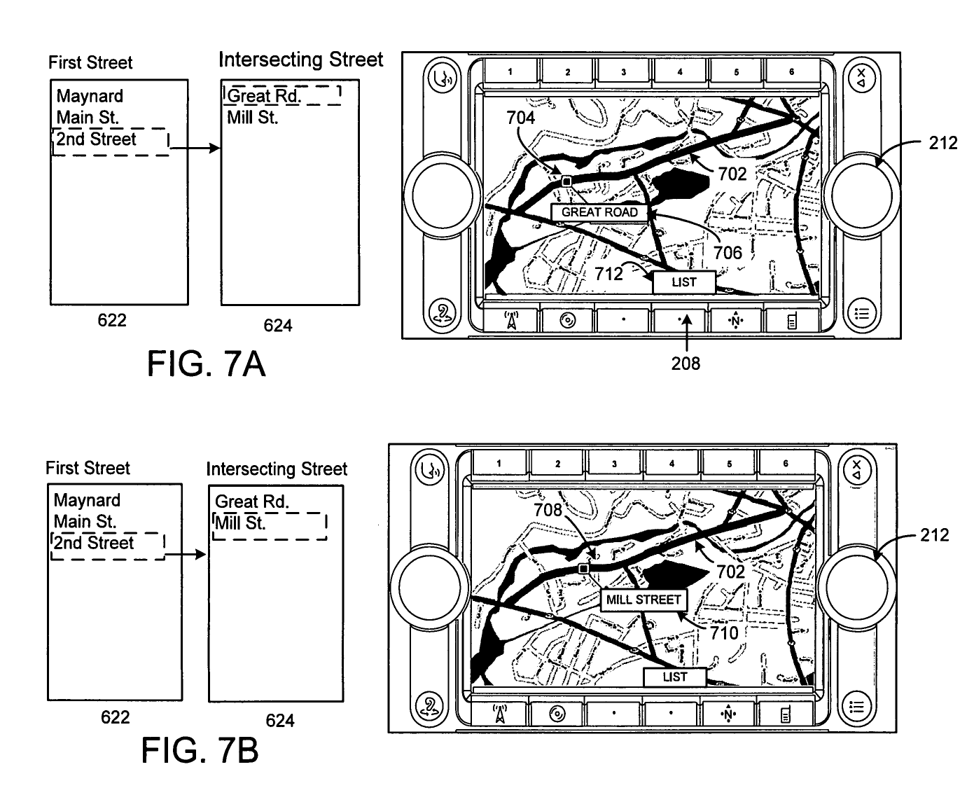

In other examples of selecting a street, in particular a street from level 624 of a database intersecting a previously selected street from level 622, (shown in FIGS. 7A and 7B) a street 702 is darkened to indicate that it has already been selected as the first street of an intersection. An intersection 704 of a second street is indicated by a callout 706, which displays the name of that second street, “Great Road.” The text 712 indicates that the corresponding one of the buttons 208 will toggle the display to a list view of intersecting streets. Turning the knob 212 changes the currently selected intersecting street, as seen in FIG. 7B where intersection 704 (FIG. 7A) has been replaced by the intersection 708, and the callout 706 has been replaced by the callout 710 indicating the name of the newly selected intersecting street, “Mill St.”

A visual display could also be used to select the first street of an intersection, with each possible street highlighted in turn in the same manner that the street 702 is highlighted in FIGS. 7A and 7B. Turning knob 212 may change which street is selected according to a hierarchy, e.g., larger roads are selected first, or longer roads are selected first, smaller roads selected second, or alphabetically, or in order across the screen, or in some other manner.

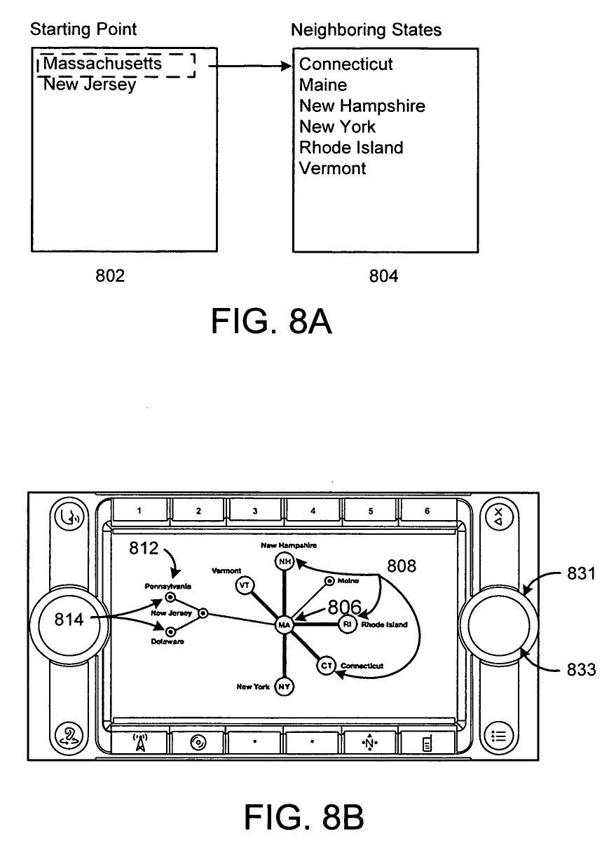

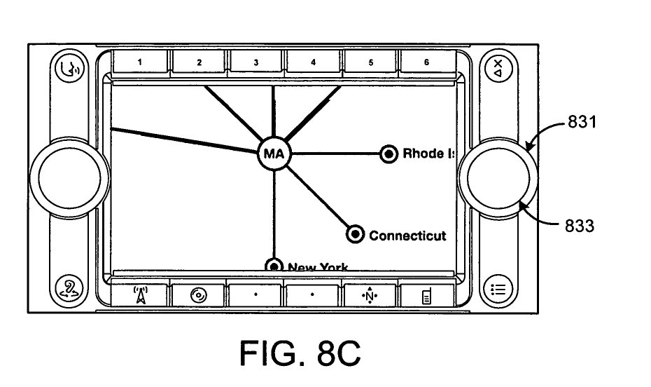

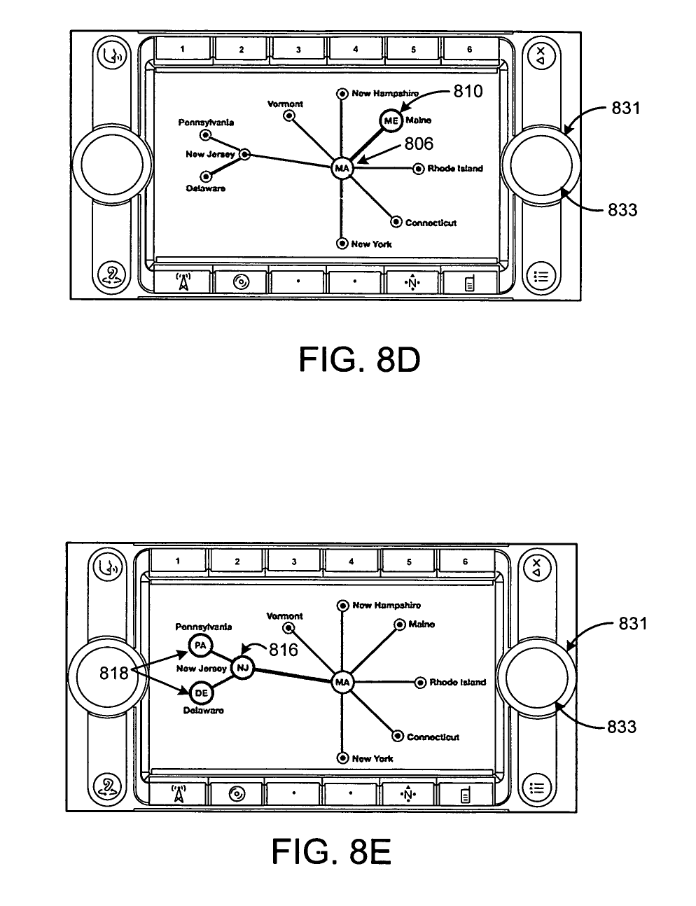

In some implementations, a vehicle navigation system enables a user to browse geographical locations (e.g., possible destinations) using an abstract spatial representation that includes, for example, cities and states. FIG. 8A shows nodes in levels of an example hierarchical database that supports this function. One level 802 of the hierarchy lists states for which the navigation system has location information. Another level 804 contains states neighboring a state selected from the level 802. Other levels may include counties, cities, roads, and intersections, and reflect their adjacency relationships, for example.

FIG. 8B shows an example of a user interface for accessing information from the hierarchical database. The states in levels 802 and 804 are displayed schematically in a hub and spoke display. By providing the user with an interface that is simpler than a typical map, he is able to browse the available destinations more easily than using a map and without needing to resort to spelling the street name.

The user interface provides an outer knob 831 that enables a user to scroll through the spokes visually to select one. An inner knob 833 allows the user to zoom in and out on the selected spoke. FIG. 8C shows the display of FIG. 8B after zooming in.

In the example, a circle hub 806 may be the state in which the user's vehicle is currently located (Massachusetts) or a state that the user has chosen by browsing a list of states or a schematic representation of the states. Neighboring states to the hub state from level 804 of the database are displayed as dots, e.g., the dots 808 for New Hampshire, Rhode Island, and Connecticut. The dots for each neighboring state may be positioned in a direction and at a distance from the circle 806 corresponding to the relative geographic locations of the states. The dots 812 and 814 show additional states that are available in level 802 and 804, respectively, but are grayed because they do not border Massachusetts.

As a user rotates the knob 831, the selected state changes among the states in the items of level 804, as shown in FIG. 8D, in which Maine is the presently selected state 810. Pressing the knob 833 or another designated button then refocuses the presentation on Maine, which becomes the new hub.

If New Jersey were selected in FIG. 8D and the knob 833 pressed, the display would change to FIG. 8E. New Jersey is now represented by a circle 816. The level 804 now contains a set of records corresponding to the states neighboring New Jersey, hence neighboring states Pennsylvania and Delaware are represented on the schematic by 818.

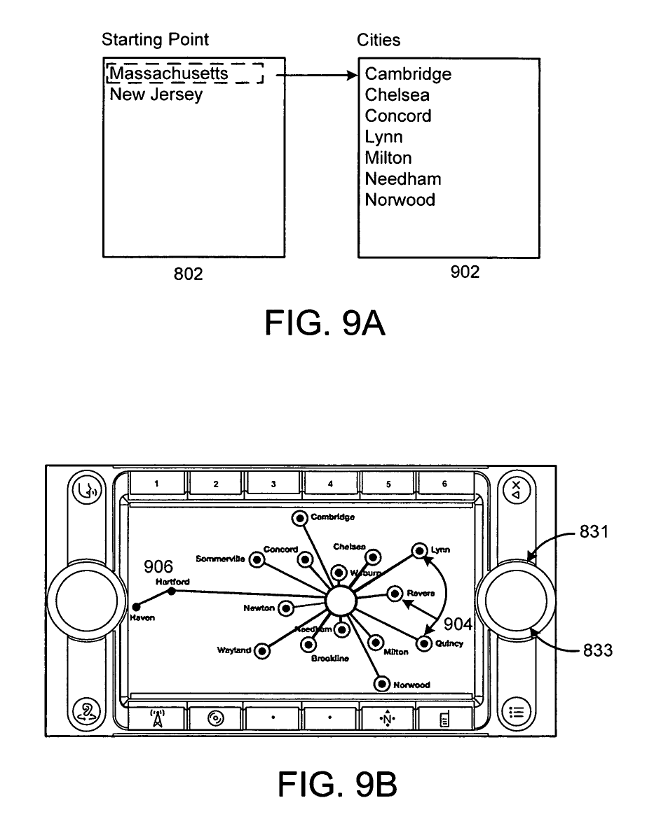

Pressing the knob 831 or another designated button while a state is highlighted as the hub changes the display to the next level of the hierarchy, as shown in FIGS. 9A and 9B, in which a set of items in a level 902 represent cities located within Massachusetts, the selected item from level 802. The states previously displayed are replaced by cities represented by dots, e.g., the dots 904 for Lynn, Revere, and Quincy. In this example, the cities are positioned in a direction and at a distance from a central circle corresponding to their geographic location relative to Boston. Additional cities are shown by the dots 906, which are lighter in color indicating that they are not within the currently selected state. Rotating the knob 831 will select among the cities as in the previous examples.

An icon showing progress through a set of records, as in FIGS. 2B, 2C, 3A, 3B, and 6B, is shown in more detail in FIG. 10. The icon 222 is surrounded by a ring 1004. An arc 1002 is displayed over a portion of ring 1004. The angle of the arc corresponds to the position of a presently active record in a list of all records in the present set. In FIG. 10, arc 1002 has an angle of 120 degrees (out of a possible 360), indicating that a presently selected record (Delta) occupies a position ⅓ into the list of records in level 1006 of a hierarchical database. The first record, Alpha, would be represented by a 30 degree arc, while the final record, Mu, would be represented by a full circle (not shown). In comparing FIG. 2A to FIG. 3A, the size of icon 222 decreases after a selection is made at the first level for which it is displayed.

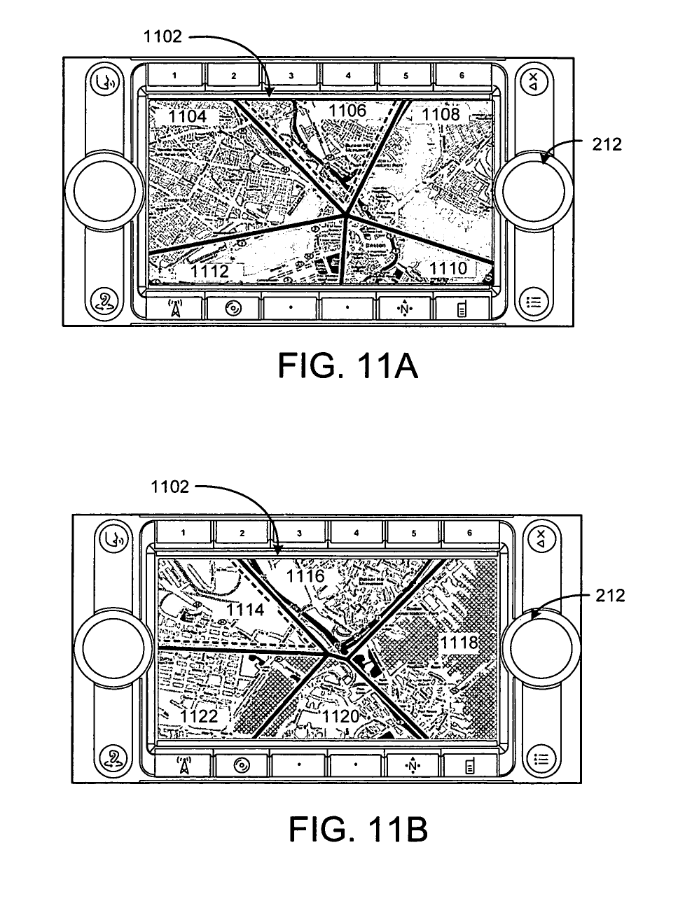

Several methods of determining the scope of a search, as discussed above, are facilitated by the visual display. For example, as shown in FIG. 11A, a displayed map 1102 may be broken into arbitrary pie segments 1104, 1106, 1108, 1110, and 1112. The map 1102 could also be broken into areas in other ways, such as in a grid or by geographic or political divisions. A user could visually browse the displayed areas by rotating the knob 212 as in the other examples, with different areas of the map being highlighted in succession. When a desired area is highlighted, e.g., the area 1106, the area is selected by pressing the knob 212 or another button, and other functions specific to the highlighted area are made available. This process may be useful for panning and scrolling through a map, for example. When a segment is selected, the user can zoom into that section, which may be broken into a number of new sub-area segments, which can be visually browsed as before. As shown in FIG. 11B, the area 1106 has been enlarged to fill the display area 1102, and new areas 1114, 1116, 1118, 1120, and 1122 are displayed, with the area 1114 selected. A method for zooming out from a selected area can also easily be accommodated.

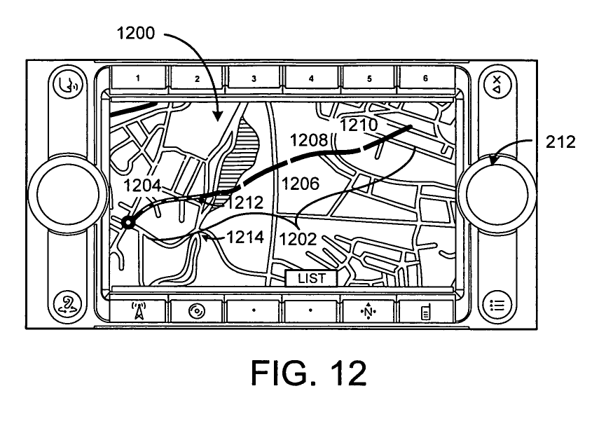

One useful application is to visually browse along a calculated route. The calculated route can be divided up into segments, as shown in FIG. 12. A database is searched to identify all segments 1204, 1206, 1208, and 1210 associated with the selected route 1202, all of which are displayed in map 1200. By turning the knob 212, or activating another control, various segments along the route are highlighted as in other examples. In FIG. 12, the segment 1204 is highlighted, as shown by a dotted line 1212. A zoom function could be provided to enable display of greater detail of a highlighted route section.

The hierarchy being browsed can relate to any information stored in any manner for use in any context.

A wide variety of user interface devices may be used as part of the method, including speech recognition.

Instead of requiring the user to turn the knob to advance the display to the next item at a level of the hierarchy, the advancing could be done automatically and the user could make a selection during a period when an item is being displayed.

In addition to browsing item by item at the bottom level of the hierarchy, e.g., one Chinese restaurant after another, the user may also browse through successive items at a higher level of the hierarchy. For example, turning the knob could first highlight all Chinese restaurants than all Italian restaurants, and so forth.

Other implementations are within the scope of the following claims.

For example, as an alternative to highlighting the visible indicia associated with respective stored items during browsing, a cursor could be displayed that would visually track the successive items for the user without highlighting them. The cursor could, for example, move from road segment to road segment along a route (where the road segments are the stored items) during rotation of the knob.

What is claimed is:

1. A method comprising
displaying a geographical field including indicia, representing respective items stored in a navigation system, displayed in positions that correspond to geographic relationships of the items on the geographic field, and
in response to a user manipulating a user interface control device, altering a visible feature of the geographic field to indicate browsing with respect to a predetermined succession of the stored items.

2. The method of claim 1 in which altering a visible feature comprises changing an appearance of at least one of the indicia.

3. The method of claim 1 in which the items comprise points of interest in a vicinity of a route on the geographical field.

4. The method of claim 1 also including simultaneously displaying text identifiers of at least some of the selected items in positions that do not correspond to geographic relationships of the items.

5. The method of claim 1 in which the indicia are displayed as a hub representing one of the items and spokes representing other items that have a geographical relationship to the one item, the angles of the spokes and the distances separating the hub and the spokes being representative of the directions and distances among the items represented by the hub and the spokes.

6. The method of claim 1 also including
enabling the user selectively to cause, at one time, either a geographical display of the indicia, text identifying the selected items, or both a geographical display of the indicia and text identifying the selected items.

7. The method of claim 1 in which the geographical field is represented as a map of a region being browsed and the indicia are displayed on the map.

8. The method of claim 1 in which the stored items are organized in hierarchical levels.

9. The method of claim 8 in which the items represented by the indicia belong to one of the levels.

10. The method of claim 8 also including
enabling the user to select items at each of at least two different hierarchical levels by manipulating the user interface.

11. The method of claim 1 in which the items comprise points of interest.

12. The method of claim 1 also including displaying a cursor to indicate currently selected items.

13. The method of claim 12 also including, in response to a user request, providing additional information about currently selected items.

14. The method of claim 1 in which manipulating a control device comprises turning a knob.

15. The method of claim 1 in which the visible feature of the geographic field comprises a cursor, and altering the visible feature comprises causing the cursor to point to successive indicia representing the stored items.

16. The method of claim 1 in which the predetermined succession of items is determined automatically.

17. The method of claim 1 in which the user manipulating the user interface control device is not associated with an inherent geographic aspect.

18. The method of claim 1 in which the user manipulating the user interface control device requires no knowledge by the user of the location on the geographical field of the next item in the predetermined succession of items.
